(19) United States
(12) Patent Application Publication
(10) Pub. No.: US 2026/0004126 A1
(43) Pub. Date: Jan. 1, 2026

(54) Implementing a Model Agnostic Framework to Provide Shapley Values Associated With a Machine Learning Model

(71) Applicant: Visa International Service Association, San Francisco, CA (US)

(72) Inventors: Yong Zhao, Austin, TX (US); Can Liu, Lucas, TX (US); Runxin He, Cedar Park, TX (US); Nicholas Stephen Kersting, Austin, TX (US); Shubham Agrawal, Round Rock, TX (US); Chiranjeet Chetia, Round Rock, TX (US); Mingji Lou, Cedar Park, TX (US); Yu Gu, Austin, TX (US)

(21) Appl. No.: 19/126,839

(22) PCT Filed: Jul. 11, 2024
(86) PCT No.: PCT/US24/37564

§ 371 Date: May 2, 2025

Related U.S. Application Data
(60) Provisional application No. 63/526,230, filed on Jul. 12, 2023.

(51) Int. Cl. G06N 3/08

(52) U.S. Cl. CPC G06N 3/08

(57) ABSTRACT

Methods, systems, and computer program products are provided for implementing a model agnostic framework to provide Shapley values associated with a machine learning model. A method may include receiving an executable file for a neural network machine learning model, converting a format of the executable file for the neural network machine learning model to an agnostic model format to provide an agnostic model format file for the neural network machine learning model, parsing the agnostic model format file, to provide a forward symbolic graph associated with the neural network machine learning model and a backward symbolic graph associated with the neural network machine learning model, receiving a real-time inference request, and determining an output of the neural network machine learning model associated with the real-time inference request and one or more Shapley values associated with the output of the neural network machine learning model.

### CROSS-REFERENCE TO RELATED APPLICATION

This application claims priority to U.S. Provisional Patent Application No. 63/526,230 filed on Jul. 12, 2023, the disclosure of which is hereby incorporated by reference in its entirety.

### BACKGROUND

### 1. Technical Field

The present disclosure relates generally to analysis of machine learning models and, in some particular embodiments or aspects, to methods, systems, and computer program products for implementing a model agnostic framework to provide Shapley values associated with a machine learning model.

### 2. Technical Considerations

Model explainability (e.g., Model Interpretability or Machine Learning Model Transparency) may refer to the concept of being able to understand a machine learning model. In some instances, model explainability may include a machine learning explanation, which is a set of views of model function, that helps a user to understand results predicted by a machine learning model. Some methods for providing model explanations may include coefficients of logistic regressions, LIME, Shapley values techniques (e.g., QII, SHAP), and integrated gradient explanations.

Shapley value-based techniques may be algorithmically interpretable methods and/or model-agnostic methods. Shapley value-based techniques assume no access to model internals and may be applied to any model type. Shapley value-based techniques may involve a core algorithm that can be applied to any input but may be used to explain the constituent features of a machine learning model. Further Shapley value-based explanations can be used to ascertain both local and/or global model reasoning for a variety of model outputs (e.g., probability, regression, classification outcomes, etc.).

A Shapley value may be a value arrived at by using fair allocation results from cooperative game theory to allocate credit for an output of a machine learning model among the input features that resulted in the output. In some instances, a Shapley value may be computed by carefully perturbing input features and seeing how changes to the input features correspond to a final model prediction. The Shapley value of a given feature may then be calculated as the average marginal contribution to the final model prediction (e.g., an overall model score).

However, current model explainability techniques, such as SHAP, may not be capable of acquiring outputs (e.g., model scores) and model explanations simultaneously. Further, such techniques may require large amounts of resources to give explanations and may require inordinate amounts of memory. Moreover, such techniques may support machine learning models written in only specific languages, such as SHAP's requirement for machine learning models written in PyTorch or TensorFlow.

### SUMMARY

Accordingly, provided are improved methods, systems, and computer program products for implementing a model agnostic framework to provide Shapley values associated with a machine learning model.

According to non-limiting embodiments or aspects, provided is a method for implementing a model agnostic framework to provide Shapley values associated with a machine learning model, that includes receiving an executable file for a neural network machine learning model; converting a format of the executable file for the neural network machine learning model to an agnostic model format to provide an agnostic model format file for the neural network machine learning model; parsing the agnostic model format file for the neural network machine learning model, wherein parsing the agnostic model format file for the neural network machine learning model comprises: storing a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model; generating a forward symbolic graph associated with the neural network machine learning model; and generating a backward symbolic graph associated with the neural network machine learning model based on the forward symbolic graph; receiving a real-time inference request for the neural network machine learning model; determining an output of the neural network machine learning model associated with the real-time inference request using the neural network machine learning model; and determining one or more Shapley values associated with the output of the neural network machine learning model based on the backward symbolic graph and the plurality of intermediate weights and the plurality of reference outputs of the neural network machine learning model stored in the cache memory location.

In some non-limiting embodiments or aspects, the method further comprising: generating a loss function for the neural network machine learning model based on a difference between an output of the forward symbolic graph and the reference input data provided to the neural network machine learning model.

In some non-limiting embodiments or aspects, generating the backward symbolic graph associated with the neural network machine learning model comprises: generating the backward symbolic graph associated with the neural network machine learning model based on the loss function for the neural network machine learning model.

In some non-limiting embodiments or aspects, wherein the forward symbolic graph comprises a plurality of nodes and a plurality of edges, and wherein generating the backward symbolic graph associated with the neural network machine learning model comprises: computing a gradient between neighboring nodes of the plurality of nodes of the forward symbolic graph; and generating a plurality of nodes and a plurality of edges of the backward symbolic graph based on the gradient between neighboring nodes of the plurality of nodes of the forward symbolic graph.

In some non-limiting embodiments or aspects, wherein generating the backward symbolic graph associated with the neural network machine learning model comprises: generating the backward symbolic graph associated with the neural network machine learning model to include one linear operator and one nonlinear operator.

In some non-limiting embodiments or aspects, wherein determining the one or more Shapley values associated with the output of the neural network machine learning model comprises: applying an automatic differentiation algorithm to the backward symbolic graph.

In some non-limiting embodiments or aspects, the method further comprising: determining a fraud detection score based on the output of the neural network machine learning model, wherein the one or more Shapley values associated with the output of the neural network machine learning model comprise an indication of one or more features of input data included in the real-time inference request that affected the fraud detection score.

According to non-limiting embodiments or aspects, provided is a system for implementing a model agnostic framework to provide Shapley values associated with a machine learning model, that includes at least one processor configured to receive an executable file for a neural network machine learning model; convert a format of the executable file for the neural network machine learning model to an agnostic model format to provide an agnostic model format file for the neural network machine learning model; parse the agnostic model format file for the neural network machine learning model, wherein, when parsing the agnostic model format file for the neural network machine learning model, the at least one processor is configured to: store a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model; generate a forward symbolic graph associated with the neural network machine learning model; and generate a backward symbolic graph associated with the neural network machine learning model based on the forward symbolic graph; receive a real-time inference request for the neural network machine learning model; determine an output of the neural network machine learning model associated with the real-time inference request using the neural network machine learning model; and determine one or more Shapley values associated with the output of the neural network machine learning model based on the backward symbolic graph and the plurality of intermediate weights and the plurality of reference outputs of the neural network machine learning model stored in the cache memory location.

In some non-limiting embodiments or aspects, the at least one processor is further configured to: generate a loss function for the neural network machine learning model based on a difference between an output of the forward symbolic graph and the reference input data provided to the neural network machine learning model.

In some non-limiting embodiments or aspects, wherein, when generating the backward symbolic graph associated with the neural network machine learning model, the at least one processor is configured to: generate the backward symbolic graph associated with the neural network machine learning model based on the loss function for the neural network machine learning model.

In some non-limiting embodiments or aspects, wherein the forward symbolic graph comprises a plurality of nodes and a plurality of edges, and wherein, when generating the backward symbolic graph associated with the neural network machine learning model, the at least one processor is configured to: compute a gradient between neighboring nodes of the plurality of nodes of the forward symbolic graph; and generate a plurality of nodes and a plurality of edges of the backward symbolic graph based on the gradient between neighboring nodes of the plurality of nodes of the forward symbolic graph.

In some non-limiting embodiments or aspects, wherein, when generating the backward symbolic graph associated with the neural network machine learning model, the at least one processor is configured to: generate the backward symbolic graph associated with the neural network machine learning model to include one linear operator and one nonlinear operator.

In some non-limiting embodiments or aspects, wherein, when determining the one or more Shapley values associated with the output of the neural network machine learning model, the at least one processor is configured to: apply an automatic differentiation algorithm to the backward symbolic graph.

In some non-limiting embodiments or aspects, wherein the at least one processor is further configured to: determine a fraud detection score based on the output of the neural network machine learning model; and wherein the one or more Shapley values associated with the output of the neural network machine learning model comprise an indication of one or more features of input data included in the real-time inference request that affected the fraud detection score.

According to non-limiting embodiments or aspects, provided is a computer program product for implementing a model agnostic framework to provide Shapley values associated with a machine learning model, that includes at least one non-transitory computer-readable medium including program instructions that, when executed by at least one processor, cause the at least one processor to receive an executable file for a neural network machine learning model; convert a format of the executable file for the neural network machine learning model to an agnostic model format to provide an agnostic model format file for the neural network machine learning model; parse the agnostic model format file for the neural network machine learning model, wherein, the program instructions that cause the at least one processor to parse the agnostic model format file for the neural network machine learning model, cause the at least one processor to: store a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model; generate a forward symbolic graph associated with the neural network machine learning model; and generate a backward symbolic graph associated with the neural network machine learning model based on the forward symbolic graph; receive a real-time inference request for the neural network machine learning model; determine an output of the neural network machine learning model associated with the real-time inference request using the neural network machine learning model; and determine one or more Shapley values associated with the output of the neural network machine learning model based on the backward symbolic graph and the plurality of intermediate weights and the plurality of reference outputs of the neural network machine learning model stored in the cache memory location.

In some non-limiting embodiments or aspects, the program instructions further cause the at least one processor to: generate a loss function for the neural network machine learning model based on a difference between an output of the forward symbolic graph and the reference input data provided to the neural network machine learning model.

In some non-limiting embodiments or aspects, the program instructions that cause the at least one processor to generate the backward symbolic graph associated with the neural network machine learning model, cause the at least one processor to: generate the backward symbolic graph associated with the neural network machine learning model based on the loss function for the neural network machine learning model.

In some non-limiting embodiments or aspects, the forward symbolic graph comprises a plurality of nodes and a plurality of edges, and wherein, the program instructions that cause the at least one processor to generate the backward symbolic graph associated with the neural network machine learning model, cause the at least one processor to: compute a gradient between neighboring nodes of the plurality of nodes of the forward symbolic graph; and generate a plurality of nodes and a plurality of edges of the backward symbolic graph based on the gradient between neighboring nodes of the plurality of nodes of the forward symbolic graph.

In some non-limiting embodiments or aspects, the program instructions that cause the at least one processor to generate the backward symbolic graph associated with the neural network machine learning model, cause the at least one processor to: generate the backward symbolic graph associated with the neural network machine learning model to include one linear operator and one nonlinear operator.

In some non-limiting embodiments or aspects, the program instructions that cause the at least one processor to determine the one or more Shapley values associated with the output of the neural network machine learning model, cause the at least one processor to: apply an automatic differentiation algorithm to the backward symbolic graph.

In some non-limiting embodiments or aspects, the program instructions further cause the at least one processor to: determine a fraud detection score based on the output of the neural network machine learning model; and wherein the one or more Shapley values associated with the output of the neural network machine learning model comprise an indication of one or more features of input data included in the real-time inference request that affected the fraud detection score.

Further non-limiting embodiments or aspects will be set forth in the following numbered clauses:

Clause 1: A computer-implemented method, comprising: receiving, with at least one processor, an executable file for a neural network machine learning model; converting, with at least one processor, a format of the executable file for the neural network machine learning model to an agnostic model format to provide an agnostic model format file for the neural network machine learning model; parsing, with at least one processor, the agnostic model format file for the neural network machine learning model, wherein parsing the agnostic model format file for the neural network machine learning model comprises: storing, with at least one processor, a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model; generating, with at least one processor, a forward symbolic graph associated with the neural network machine learning model; and generating, with at least one processor, a backward symbolic graph associated with the neural network machine learning model based on the forward symbolic graph; receiving, with at least one processor, a real-time inference request for the neural network machine learning model; determining, with at least one processor, an output of the neural network machine learning model associated with the real-time inference request using the neural network machine learning model; and determining, with at least one processor, one or more Shapley values associated with the output of the neural network machine learning model based on the backward symbolic graph and the plurality of intermediate weights and the plurality of reference outputs of the neural network machine learning model stored in the cache memory location.

Clause 2: The computer-implemented method of clause 1, further comprising: generating a loss function for the neural network machine learning model based on a difference between an output of the forward symbolic graph and the reference input data provided to the neural network machine learning model.

Clause 3: The computer-implemented method of clause 1 or 2, wherein generating the backward symbolic graph associated with the neural network machine learning model comprises: generating the backward symbolic graph associated with the neural network machine learning model based on the loss function for the neural network machine learning model.

Clause 4: The computer-implemented method of any of clauses 1-3, wherein the forward symbolic graph comprises a plurality of nodes and a plurality of edges, and wherein generating the backward symbolic graph associated with the neural network machine learning model comprises: computing a gradient between neighboring nodes of the plurality of nodes of the forward symbolic graph; and generating a plurality of nodes and a plurality of edges of the backward symbolic graph based on the gradient between neighboring nodes of the plurality of nodes of the forward symbolic graph.

Clause 5: The computer-implemented method of any of clauses 1-4, wherein generating the backward symbolic graph associated with the neural network machine learning model comprises: generating the backward symbolic graph associated with the neural network machine learning model to include one linear operator and one nonlinear operator.

Clause 6: The computer-implemented method of any of clauses 1-5, wherein determining the one or more Shapley values associated with the output of the neural network machine learning model comprises: applying an automatic differentiation algorithm to the backward symbolic graph.

Clause 7: The computer-implemented method of any of clauses 1-6, further comprising: determining a fraud detection score based on the output of the neural network machine learning model, wherein the one or more Shapley values associated with the output of the neural network machine learning model comprise an indication of one or more features of input data included in the real-time inference request that affected the fraud detection score.

Clause 8: A system, comprising: at least one processor configured to: receive an executable file for a neural network machine learning model; convert a format of the executable file for the neural network machine learning model to an agnostic model format to provide an agnostic model format file for the neural network machine learning model; parse the agnostic model format file for the neural network machine learning model, wherein, when parsing the agnostic model format file for the neural network machine learning model, the at least one processor is configured to: store a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model; generate a forward symbolic graph associated with the neural network machine learning model; and generate a backward symbolic graph associated with the neural network machine learning model based on the forward symbolic graph; receive a real-time inference request for the neural network machine learning model; determine an output of the neural network machine learning model associated with the real-time inference request using the neural network machine learning model; and determine one or more Shapley values associated with the output of the neural network machine learning model based on the backward symbolic graph and the plurality of intermediate weights and the plurality of reference outputs of the neural network machine learning model stored in the cache memory location.

Clause 9: The system of clause 8, wherein the at least one processor is further configured to: generate a loss function for the neural network machine learning model based on a difference between an output of the forward symbolic graph and the reference input data provided to the neural network machine learning model.

Clause 10: The system of clause 8 or 9, wherein, when generating the backward symbolic graph associated with the neural network machine learning model, the at least one processor is configured to: generate the backward symbolic graph associated with the neural network machine learning model based on the loss function for the neural network machine learning model.

Clause 11: The system of any of clauses 8-10, wherein the forward symbolic graph comprises a plurality of nodes and a plurality of edges, and wherein, when generating the backward symbolic graph associated with the neural network machine learning model, the at least one processor is configured to: compute a gradient between neighboring nodes of the plurality of nodes of the forward symbolic graph; and generate a plurality of nodes and a plurality of edges of the backward symbolic graph based on the gradient between neighboring nodes of the plurality of nodes of the forward symbolic graph.

Clause 12: The system of any of clauses 8-11, wherein, when generating the backward symbolic graph associated with the neural network machine learning model, the at least one processor is configured to: generate the backward symbolic graph associated with the neural network machine learning model to include one linear operator and one nonlinear operator.

Clause 13: The system of any of clauses 8-12, wherein, when determining the one or more Shapley values associated with the output of the neural network machine learning model, the at least one processor is configured to: apply an automatic differentiation algorithm to the backward symbolic graph.

Clause 14: The system of any of clauses 8-13, wherein the at least one processor is further configured to: determine a fraud detection score based on the output of the neural network machine learning model; and wherein the one or more Shapley values associated with the output of the neural network machine learning model comprise an indication of one or more features of input data included in the real-time inference request that affected the fraud detection score.

Clause 15: A computer program product comprising at least one non-transitory computer-readable medium including program instructions that, when executed by at least one processor, cause the at least one processor to: receive an executable file for a neural network machine learning model; convert a format of the executable file for the neural network machine learning model to an agnostic model format to provide an agnostic model format file for the neural network machine learning model; parse the agnostic model format file for the neural network machine learning model, wherein, the program instructions that cause the at least one processor to parse the agnostic model format file for the neural network machine learning model, cause the at least one processor to: store a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model; generate a forward symbolic graph associated with the neural network machine learning model; and generate a backward symbolic graph associated with the neural network machine learning model based on the forward symbolic graph; receive a real-time inference request for the neural network machine learning model; determine an output of the neural network machine learning model associated with the real-time inference request using the neural network machine learning model; and determine one or more Shapley values associated with the output of the neural network machine learning model based on the backward symbolic graph and the plurality of intermediate weights and the plurality of reference outputs of the neural network machine learning model stored in the cache memory location.

Clause 16: The computer program product of clause 15, wherein the program instructions further cause the at least one processor to: generate a loss function for the neural network machine learning model based on a difference between an output of the forward symbolic graph and the reference input data provided to the neural network machine learning model.

Clause 17: The computer program product of clause 15 or 16, wherein, the program instructions that cause the at least one processor to generate the backward symbolic graph associated with the neural network machine learning model, cause the at least one processor to: generate the backward symbolic graph associated with the neural network machine learning model based on the loss function for the neural network machine learning model.

Clause 18: The computer program product of any of clauses 15-17, wherein the forward symbolic graph comprises a plurality of nodes and a plurality of edges, and wherein, the program instructions that cause the at least one processor to generate the backward symbolic graph associated with the neural network machine learning model, cause the at least one processor to: compute a gradient between neighboring nodes of the plurality of nodes of the forward symbolic graph; and generate a plurality of nodes and a plurality of edges of the backward symbolic graph based on the gradient between neighboring nodes of the plurality of nodes of the forward symbolic graph.

Clause 19: The computer program product of any of clauses 15-18, wherein, the program instructions that cause the at least one processor to generate the backward symbolic graph associated with the neural network machine learning model, cause the at least one processor to: generate the backward symbolic graph associated with the neural network machine learning model to include one linear operator and one nonlinear operator.

Clause 20: The computer program product of any of clauses 15-19, wherein, the program instructions that cause the at least one processor to determine the one or more Shapley values associated with the output of the neural network machine learning model, cause the at least one processor to: apply an automatic differentiation algorithm to the backward symbolic graph.

Clause 21: The computer program product of any of clauses 15-20, wherein the program instructions further cause the at least one processor to: determine a fraud detection score based on the output of the neural network machine learning model; and wherein the one or more Shapley values associated with the output of the neural network machine learning model comprise an indication of one or more features of input data included in the real-time inference request that affected the fraud detection score.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the present disclosure are explained in greater detail below with reference to the exemplary embodiments that are illustrated in the accompanying figures, in which:

FIG. 1 is a diagram of a non-limiting embodiment or aspect of an environment in which systems, devices, products, apparatus, and/or methods, described herein, may be implemented, according to the principles of the present disclosure;

FIG. 2 is a flowchart of a non-limiting embodiment or aspect of a process for implementing a model agnostic framework to provide Shapley values associated with a machine learning model;

FIGS. 3A-3D are schematic diagrams of an exemplary implementation of a system and/or method for implementing a model agnostic framework to provide Shapley values associated with a machine learning model, according to some non-limiting embodiments or aspects;

FIG. 4 is a diagram of an exemplary environment in which systems, methods, and/or computer program products, described herein, may be implemented, according to some non-limiting embodiments or aspects; and

FIG. 5 is a schematic diagram of example components of one or more devices of FIG. 1 and/or FIG. 4, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device (e.g., a payment card, such as a credit or debit card), a gift card, a smartcard, smart media, a payroll card, a healthcare card, a wristband, a machine-readable medium containing account information, a keychain device or fob, a radio frequency identification (RFID) transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, RFID receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to methods, systems, and computer program products for implementing a model agnostic framework to provide Shapley values associated with a machine learning model. In some non-limiting embodiments or aspects, a model explanation system may receive a file (e.g., an executable file) for a neural network machine learning model, convert a format of the file for the neural network machine learning model to a model agnostic format (e.g., an Open Neural Network exchange (ONNX) format) to provide a model agnostic file (e.g., an ONNX file) for the neural network machine learning model, and parse the model agnostic file for the neural network machine learning model. In some non-limiting embodiments or aspects, when parsing the model agnostic file for the neural network machine learning model, the model explanation system may store intermediate weights and a plurality of reference outputs of the neural network machine learning model in a cache memory location, where the intermediate weights and the plurality of reference outputs of the neural network machine learning model are based on reference input data provided to the neural network machine learning model, generate a forward symbolic graph associated with the neural network machine learning model, and generate a backward symbolic graph associated with the neural network machine learning model based on the forward symbolic graph. In some non-limiting embodiments or aspects, the model explanation system may receive a real-time inference request for the neural network machine learning model, determine an output of the neural network machine learning model associated with the real-time inference request using the neural network machine learning model, and determine one or more Shapley values associated with the output of the neural network machine learning model based on the backward symbolic graph and the intermediate weights and the plurality of reference outputs of the neural network machine learning model stored in the cache memory location.

In some non-limiting embodiments or aspects, the model explanation system may generate a loss function for the neural network machine learning model based on a difference between an output of the forward symbolic graph and the reference input data provided to the neural network machine learning model. In some non-limiting embodiments or aspects, when generating the backward symbolic graph associated with the neural network machine learning model, the model explanation system may generate the backward symbolic graph associated with the neural network machine learning model based on the loss function for the neural network machine learning model.

In some non-limiting embodiments or aspects, the forward symbolic graph comprises a plurality of nodes and edges, and when generating the backward symbolic graph associated with the neural network machine learning model, the model explanation system may compute a gradient between neighboring nodes of the plurality of nodes of the forward symbolic graph and generate a plurality of nodes and edges of the backward symbolic graph based on the gradient between neighboring nodes of the plurality of nodes of the forward symbolic graph.

In some non-limiting embodiments or aspects, when generating the backward symbolic graph associated with the neural network machine learning model, the model explanation system may generate the backward symbolic graph associated with the neural network machine learning model to include one linear operator and/or one nonlinear operator.

In some non-limiting embodiments or aspects, the model explanation system may apply an automatic differentiation algorithm to the backward symbolic graph. In some non-limiting embodiments or aspects, the model explanation system may determine a fraud detection score based on the output of the neural network machine learning model and the one or more Shapley values associated with the output of the neural network machine learning model comprise an indication of one or more features of input data included in the real-time inference request that affected the fraud detection score.

In this way, the model explanation system may be able to provide outputs (e.g., model scores that indicate an accuracy of a machine learning model with regard to an inference) and model explanations simultaneously (e.g., near simultaneously) and in real-time (e.g., a time at which or close to a time at which operations of the model explanation system are carried out). Further, the model explanation system may reduce the amount of resources necessary to give explanations and provide a quicker response time, while providing a framework that is agnostic to the type of framework (e.g., a language type) used to initially prepare a machine learning model.

For the purpose of illustration, in the following description, while the presently disclosed subject matter is described with respect to methods, systems, and computer program products for implementing a model agnostic framework to provide Shapley values associated with a machine learning model that provide an explanation of the output of a machine learning model by attributing contribution of each feature to the final output (e.g., a prediction, a model score, etc.) to provide insights into the features that have an effect on the output of the machine learning model and helps in understanding and interpreting the behavior of the machine learning model, one skilled in the art will recognize that the disclosed subject matter is not limited to the non-limiting embodiments or aspects disclosed herein. For example, methods, systems, and computer program products described herein may be used with a wide variety of settings, such as predictions, regressions, classifications, fraud prevention, authorization, authentication, feature selection, and/or the like.

For the purpose of illustration, in the following description, while the presently disclosed subject matter is described with respect to methods, systems, and computer program products for a large scale graph transformer machine learning model network architecture, which may be used in association with providing recommendations, one skilled in the art will recognize that the disclosed subject matter is not limited to the non-limiting embodiments or aspects disclosed herein. For example, methods, systems, and computer program products described herein may be used with a wide variety of settings and/or for making determinations (e.g., predictions, classifications, regressions, and/or the like), such as for fraud detection/prevention, authorization, authentication, identification, feature selection, payment processing, and/or the like.

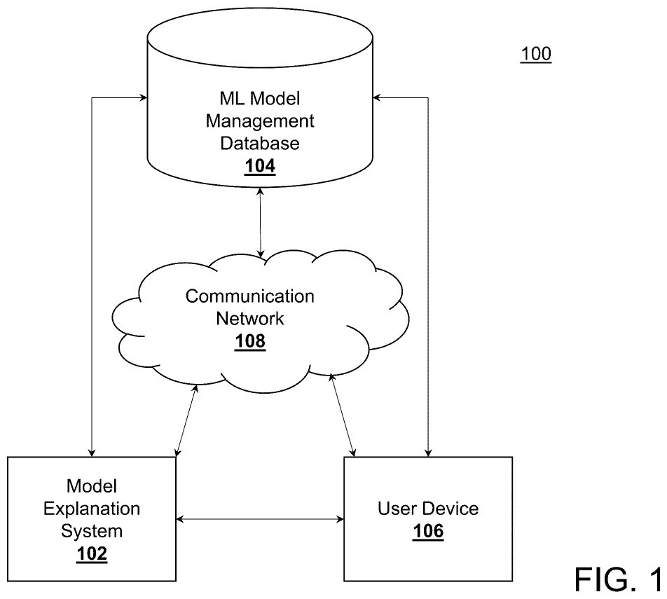

Referring now to FIG. 1, FIG. 1 is a diagram of example system 100 in which devices, systems, and/or methods, described herein, may be implemented. As shown in FIG. 1, system 100 includes model explanation system 102, machine learning (ML) model management database 104, user device 106, and communication network 108. Model explanation system 102, ML model management database 104, and/or user device 106 may interconnect (e.g., establish a connection to communicate) via wired connections, wireless connections, or a combination of wired and wireless connections.

Model explanation system 102 may include one or more devices capable of receiving information from and/or communicating information (e.g., directly via wired or wireless communication connection, indirectly via communication network 108, and/or the like) to ML model management database 104 and/or user device 106 via communication network 108. For example, model explanation system 102 may include a server, a group of servers, a cloud platform, and/or other like devices. In some non-limiting embodiments or aspects, model explanation system 102 may be associated with a transaction service provider system. For example, model explanation system 102 may be operated by a transaction service provider system. In another example, model explanation system 102 may be a component of user device 106. In another example, model explanation system 102 may include ML model management database 104. In some non-limiting embodiments or aspects, model explanation system 102 may be in communication with a data storage device (e.g., ML model management database 104), which may be local or remote to model explanation system 102. In some non-limiting embodiments or aspects, model explanation system 102 may be capable of receiving information from, storing information in, transmitting information to, and/or searching information stored in the data storage device.

In some non-limiting embodiments or aspects, model explanation system 102 may generate (e.g., train, validate, re-train, and/or the like), store, and/or implement (e.g., operate, provide inputs to and/or outputs from, and/or the like) one or more machine learning models. For example, model explanation system 102 may generate one or more machine learning models by fitting (e.g., validating, testing, etc.) one or more machine learning models against data used for training (e.g., training data). In some non-limiting embodiments or aspects, model explanation system 102 may generate, store, and/or implement one or more machine learning models that are provided for a production environment (e.g., a runtime environment, a real-time environment, etc.) used for providing inferences (e.g., secure inferences) based on data inputs in a live situation (e.g., real-time situation). Additionally or alternatively, model explanation system 102 may generate, store, and/or implement one or more machine learning models that are provided for a non-production environment (e.g., an offline environment, a training environment, etc.) used for providing inferences based on data inputs in a situation that is not live. In some non-limiting embodiments or aspects, model explanation system 102 may be in communication with a data storage device (ML model management database 104), which may be local or remote to model explanation system 102.

ML model management database 104 may include one or more devices capable of receiving information from and/or communicating information (e.g., directly via wired or wireless communication connection, indirectly via communication network 108, and/or the like) to model explanation system 102 and/or user device 106. For example, ML model management database 104 may include a server, a group of servers, a desktop computer, a portable computer, a mobile device, and/or other like devices. In some non-limiting embodiments or aspects, ML model management database 104 may include a data storage device. In some non-limiting embodiments or aspects, ML model management database 104 may be capable of receiving information from, storing information in, communicating information to, or searching information stored in the data storage device. In some non-limiting embodiments or aspects, ML model management database 104 may be part of model explanation system 102 and/or part of the same system as model explanation system 102.

User device 106 may include one or more devices capable of receiving information from and/or communicating information (e.g., directly via wired or wireless communication connection, indirectly via communication network 108, and/or the like) to model explanation system 102 and/or ML model management database 104. For example, user device 106 may include a computing device, such as a mobile device, a portable computer, a desktop computer, and/or other like devices. Additionally or alternatively, user device 106 may include a device capable of receiving information from and/or communicating information to other user devices (e.g., directly via wired or wireless communication connection, indirectly via communication network 108, and/or the like). In some non-limiting embodiments or aspects, user device 106 may be part of model explanation system 102 and/or part of the same system as model explanation system 102. For example, model explanation system 102, ML model management database 104, and user device 106 may all be (and/or be part of) a single system and/or a single computing device.

Communication network 108 may include one or more wired and/or wireless networks. For example, communication network 108 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

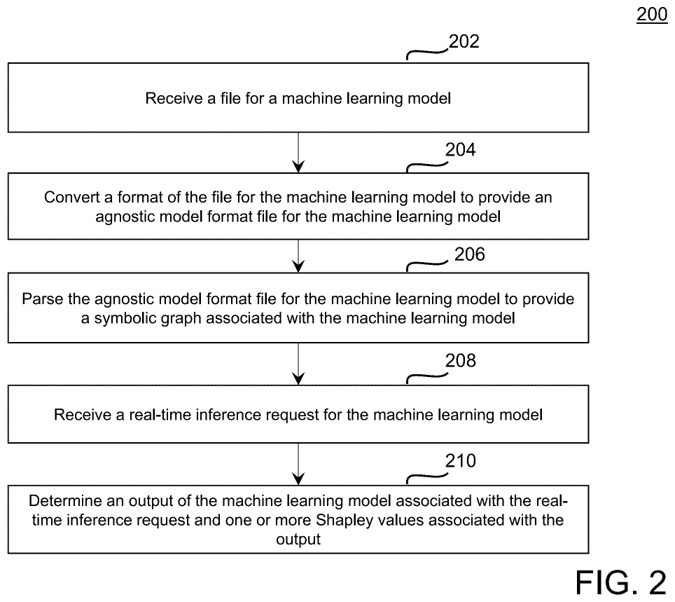

Referring now to FIG. 2, shown is a flow diagram for process 200 for implementing a model agnostic framework to provide Shapley values associated with a machine learning model, according to some non-limiting embodiments or aspects. In some non-limiting embodiments or aspects, one or more of the steps of process 200 may be performed (e.g., completely, partially, etc.) by model explanation system 102 (e.g., one or more devices of model explanation system 102). In some non-limiting embodiments or aspects, one or more of the steps of process 200 may be performed (e.g., completely, partially, etc.) by another device or a group of devices separate from or including model explanation system 102 (e.g., one or more devices of model explanation system 102), ML model management database 104, and/or user device 106. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2, at step 202, process 200 includes receiving a file for a machine learning model. For example, model explanation system 102 may receive the file for a machine learning model. In one example, the file may include an executable file for a machine learning model, such as a neural network machine learning model. In some non-limiting embodiments or aspects, the file for the machine learning model may have a format based on a type of machine learning framework used to develop the machine learning model (e.g., Keras, PyTorch, TensorFlow, Caffe, Matlab, etc.). In some non-limiting embodiments or aspects, model explanation system 102 may receive data associated with a machine learning model, which may include the file for a machine learning model. In some non-limiting embodiments or aspects, model explanation system 102 may receive the data from ML model management database 104, user device 106, and/or another system or device.

As shown in FIG. 2, at step 204, process 200 includes converting a format of the file for the machine learning model to provide an agnostic model format file for the machine learning model. For example, model explanation system 102 may convert a format of the file for the machine learning model to an agnostic model format to provide an agnostic model format file for the machine learning model. In some non-limiting embodiments or aspects, model explanation system 102 may convert a format of an executable file for a machine learning model (e.g., a neural network machine learning model) to an ONNX format to provide an ONNX file for the machine learning model. Additionally or alternatively, model explanation system 102 may convert a format of a file for a machine learning model to a standardized model format (e.g., a Predictive Model Markup Language (PMML) format, a Portable Format for Analytics (PFA) format, a TensorFlow SavedModel format, a Keras HDF5 format, a Core ML format, a MXNet Model format, a Caffe Model format, etc.) to provide a standardized model file to be used as an agnostic model format file for the machine learning model.

As shown in FIG. 2, at step 206, process 200 includes parsing the agnostic model format file for the machine learning model to provide a symbolic graph associated with the machine learning model. For example, model explanation system 102 may parse an agnostic model format file (e.g., an ONNX file) for the machine learning model to provide a forward symbolic graph and/or a backward symbolic graph associated with a machine learning model. In some non-limiting embodiments or aspects, the symbolic graph associated with the machine learning model may include a high-level representation of the computation flow of the machine learning model. The symbolic graph may include a plurality of nodes and a plurality of edges to define the structure (e.g., architecture) and/or operations of the machine learning model. In some non-limiting embodiments or aspects, each node in the symbolic graph may represent an operation (e.g., addition, multiplication, convolution, etc.) and each edge may represent a data flow between the operations.

In some non-limiting embodiments or aspects, a forward symbolic graph associated with a machine learning model may include a type of computation graph that represents a sequence of operations needed to compute an output of the machine learning model from an input provided to the machine learning model. The forward symbolic graph may define data flows through the machine learning model during forward propagation, where input data is processed to produce outputs (e.g., predictions, model scores, etc.). In some non-limiting embodiments or aspects, nodes of the forward symbolic graph may represent operations and/or layers in the machine learning model and may include mathematical functions, activation functions, layers (e.g., convolutional layers, fully connected layers, etc.), and/or other processing steps. In some non-limiting embodiments or aspects, edges of the forward symbolic graph may represent the flow of data between nodes and each edge may represent the output from one node transferred to the input of another node. In some non-limiting embodiments or aspects, a forward symbolic graph may start with one or more input nodes, which represent the raw data provided to the machine learning model, and the forward symbolic graph may end with one or more output nodes, which represent outputs. In some non-limiting embodiments or aspects, a forward symbolic graph may be deterministic, such that given the same input, the forward symbolic graph will produce the same output.

In some non-limiting embodiments or aspects, a backward symbolic graph associated with a machine learning model may represent a sequence of operations needed to compute gradients of model parameters during backpropagation. In some non-limiting embodiments or aspects, a backward symbolic graph may define how gradients are propagated back through the machine learning model to update the weights. In some non-limiting embodiments or aspects, nodes of the backward symbolic graph may represent gradient computations for each operation in forward propagation. The nodes may include gradients of loss functions, gradients of intermediate activations, and/or gradients of model parameters. In some non-limiting embodiments or aspects, edges of the backward symbolic graph may represent the flow of gradients between nodes. Each edge may represent a gradient from one node to the previous node that contributed to the computation of the gradient. In some non-limiting embodiments or aspects, a backward symbolic graph may show a flow in the reverse direction of a forward symbolic graph. The backward symbolic graph may start from a node with a loss and propagate gradients back to one or more input nodes. In some non-limiting embodiments or aspects, each node of a backward symbolic graph may correspond to a partial derivative of a loss with respect to one or more variables involved in forward propagation, and the partial derivative may be used by model explanation system 102 to update the model parameters of the machine learning model.

In some non-limiting embodiments or aspects, the forward symbolic graph and/or the backward symbolic graph may include a plurality of nodes (e.g., vertexes or vertices) and a plurality of edges. In some non-limiting embodiments or aspects, the forward symbolic graph and/or the backward symbolic graph may include a set of nodes (e.g., a set of at least 5, 10, 15, 30, 50, 100, 200, 300, etc., or more nodes) and/or a set of edges (e.g., a set of at least 5, 10, 15, 30, 50, 100, 200, 300, etc., or more edges).

In some non-limiting embodiments or aspects, model explanation system 102 may generate a plurality of intermediate weights and/or a plurality of reference outputs of a machine learning model (e.g., a neural network machine learning model) based on reference input data provided to the machine learning model. For example, model explanation system 102 may provide the reference input data as an input to the machine learning model, and the machine learning model may provide a plurality of reference outputs of a machine learning model based on the input. The plurality of intermediate weights may be generated during backpropagation as updates are made to model parameters of the machine learning model based on forward propagation of the reference input data.

In some non-limiting embodiments or aspects, model explanation system 102 may receive a dataset (e.g., a training dataset, a reference dataset, etc.) that includes the reference input data. For example, model explanation system 102 may receive the dataset from ML model management database 104. In some non-limiting embodiments or aspects, the reference input data may be associated with one or more entities of a population of entities (e.g., users, accountholders, merchants, issuers, items provided by an entity, etc.). In some non-limiting embodiments or aspects, the reference input data may include a plurality of data instances associated with a plurality of features. In some non-limiting embodiments or aspects, the plurality of data instances of the graph data may represent a plurality of interactions (e.g., transactions, such as electronic payment transactions) involving one or more entities of the population. In some examples, the reference input data may include a large amount of data instances, such as 100 data instances, 500 data instances, 1,000 data instances, 5,000 data instances, 10,000 data instances, 25,000 data instances, 50,000 data instances, 100,000 data instances, 1,000,000 data instances, and/or the like.

In some non-limiting embodiments or aspects, each data instance may include transaction data associated with the transaction. In some non-limiting embodiments or aspects, the transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a personal identification number (PIN), etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some non-limiting embodiments or aspects, model explanation system 102 may store intermediate weights and/or a plurality of reference outputs of the machine learning model. For example, model explanation system 102 may store intermediate weights and/or a plurality of reference outputs of the machine learning model in a cache memory location (e.g., a cache memory location of model explanation system 102). In this way, model explanation system 102 may be able to access the intermediate weights and/or a plurality of reference outputs of the machine learning model stored in the cache memory location more quickly than if the intermediate weights and/or a plurality of reference outputs of the machine learning model were stored in another location.

In some non-limiting embodiments or aspects, the intermediate weights and the plurality of reference outputs of the neural network machine learning model are based on reference input data provided to the neural network machine learning model. In the example above, model explanation system 102 may generate a forward symbolic graph associated with the neural network machine learning model and a backward symbolic graph associated with the neural network machine learning model. In some non-limiting embodiments or aspects, model explanation system 102 may generate the backward symbolic graph based on the forward symbolic graph.

In some non-limiting embodiments or aspects, model explanation system 102 may generate a loss function for the machine learning model based on a difference between an output of the forward symbolic graph and the reference input data provided to the machine learning model. In some non-limiting embodiments or aspects, model explanation system 102 may generate the backward symbolic graph associated with the neural network machine learning model based on the loss function for the machine learning model.

In some non-limiting embodiments or aspects, model explanation system 102 may compute a gradient associated with the forward symbolic graph. For example, model explanation system 102 may compute a gradient between neighboring nodes of the plurality of nodes of the forward symbolic graph. In some non-limiting embodiments or aspects, model explanation system 102 may generate a plurality of nodes and/or a plurality of edges of a backward symbolic graph based on a gradient associated with the forward symbolic graph. For example, model explanation system 102 may generate a plurality of nodes and/or a plurality of edges of a backward symbolic graph based on the gradient between neighboring nodes of the plurality of nodes of the forward symbolic graph. In some non-limiting embodiments or aspects, model explanation system 102 may generate the backward symbolic graph associated with the neural network machine learning model to include one linear operator and/or one nonlinear operator.

In some non-limiting embodiments or aspects, model explanation system 102 may apply an automatic differentiation algorithm to the backward symbolic graph. For example, model explanation system 102 may apply the automatic differentiation algorithm to the backward symbolic graph to optimize (e.g., simplify) the backward symbolic graph, which may then be used to generate one or more Shapley values.

As shown in FIG. 2, at step 208, process 200 includes receiving a real-time inference request for the machine learning model. For example, model explanation system 102 may receive the real-time inference request for the machine learning model. In some non-limiting embodiments or aspects, the real-time inference request may be based on a task (e.g., a classification task) for the machine learning model. For example, the real-time inference request may be based on a request to determine whether a transaction (e.g., a transaction involving a user of user device 106) is fraudulent.

As shown in FIG. 2, at step 210, process 200 includes determining an output of the machine learning model associated with the real-time inference request and one or more Shapley values associated with the output. For example, model explanation system 102 may determine an output of the machine learning model associated with the real-time inference request and/or one or more Shapley values associated with the output.

In some non-limiting embodiments or aspects, model explanation system 102 may determine the output of the machine learning model associated with an input included in the real-time inference request using the machine learning model. For example, model explanation system 102 may generate a score (e.g., a model score, a prediction score, etc.) based on an input provided to the machine learning model. In such an example, model explanation system 102 may generate the score based on an input included with an inference request that is provided to the machine learning model to generate the score. In some non-limiting embodiments or aspects, a score for an input (e.g., a data instance) may be equal to an average model score (e.g., an average model score for all inputs of a plurality of inputs) added to a sum of the Shapley values for each feature of a plurality of features included in the input.

In some non-limiting embodiments or aspects, model explanation system 102 may generate (e.g., determine) a score associated with an inference task based on an output of the machine learning model that was generated based on input data (e.g., input data included in an inference request) provided to the machine learning model as an input. In one example, model explanation system 102 may generate a fraud detection score based on the output of the machine learning model, and the one or more Shapley values associated with the output of the machine learning model may include an indication of one or more features of input data that affected the fraud detection score.

In some non-limiting embodiments or aspects, model explanation system 102 may determine the one or more Shapley values associated with the output of the machine learning model based on the backward symbolic graph, the plurality of intermediate weights, and/or the plurality of reference outputs of the machine learning model (e.g., the plurality of reference outputs of the machine learning model stored in a cache memory location). In some non-limiting embodiments or aspects, when determining the one or more Shapley values associated with the output of the neural network machine learning model, model explanation system 102 may apply an automatic differentiation algorithm to the backward symbolic graph.

In some non-limiting embodiments or aspects, model explanation system 102 may perform an action, such as a fraud prevention procedure, a transaction authorization procedure, a recommendation procedure, and/or the like, based on an output of the machine learning model and/or the one or more Shapley values associated with the output. For example, model explanation system 102 may perform the action based on determining to perform the action after analyzing the output and/or the one or more Shapley values associated with the output. In some non-limiting embodiments or aspects, model explanation system 102 may perform a fraud prevention procedure associated with protection of an account of a user (e.g., a first entity, such as a user associated with user device 106) based on an output of the machine learning model and/or the one or more Shapley values associated with the output. For example, if the output of the machine learning model and/or the one or more Shapley values associated with the output (e.g., the one or more Shapley values associated with the output having a value that indicates that the machine learning model correctly predicted that the fraud prevention procedure is necessary) indicates that the fraud prevention procedure is necessary, model explanation system 102 may perform the fraud prevention procedure associated with protection of the account of the user. In such an example, if the output of the machine learning model and/or the one or more Shapley values associated with the output (e.g., the one or more Shapley values associated with the output having a value that indicates that the machine learning model did not correctly predict that the fraud prevention procedure is necessary) indicates that the fraud prevention procedure is not necessary, model explanation system 102 may forego performing the fraud prevention procedure associated with protection of the account of the user.

In some non-limiting embodiments or aspects, model explanation system 102 may perform an action associated with the machine learning model, such as a feature selection procedure, a training (e.g., re-training) procedure, an inference task (e.g., performing a real-time inference task, such as another real-time inference task), and/or the like, based on an output of the machine learning model and/or the one or more Shapley values associated with the output. For example, model explanation system 102 may perform the action associated with the machine learning model based on determining to perform the action after analyzing the output and/or the one or more Shapley values associated with the output. In some non-limiting embodiments or aspects, model explanation system 102 may perform the action associated with the machine learning model based on an output of the machine learning model and/or the one or more Shapley values associated with the output. For example, if the output of the machine learning model and/or the one or more Shapley values associated with the output indicates that the action associated with the machine learning model is necessary, model explanation system 102 may perform the fraud prevention procedure associated with protection of the account of the user. In such an example, if the output of the machine learning model and/or the one or more Shapley values associated with the output indicates that the action associated with the machine learning model is not necessary, model explanation system 102 may forego performing the action associated with the machine learning model.

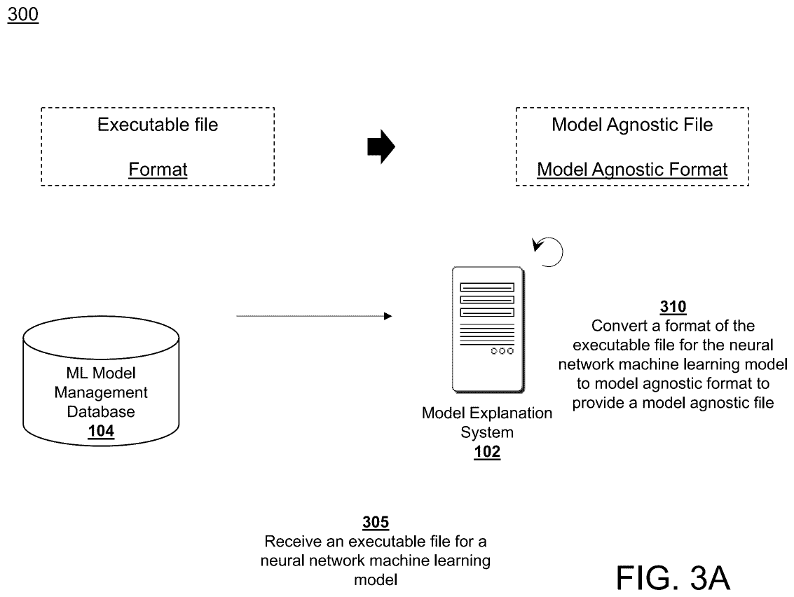

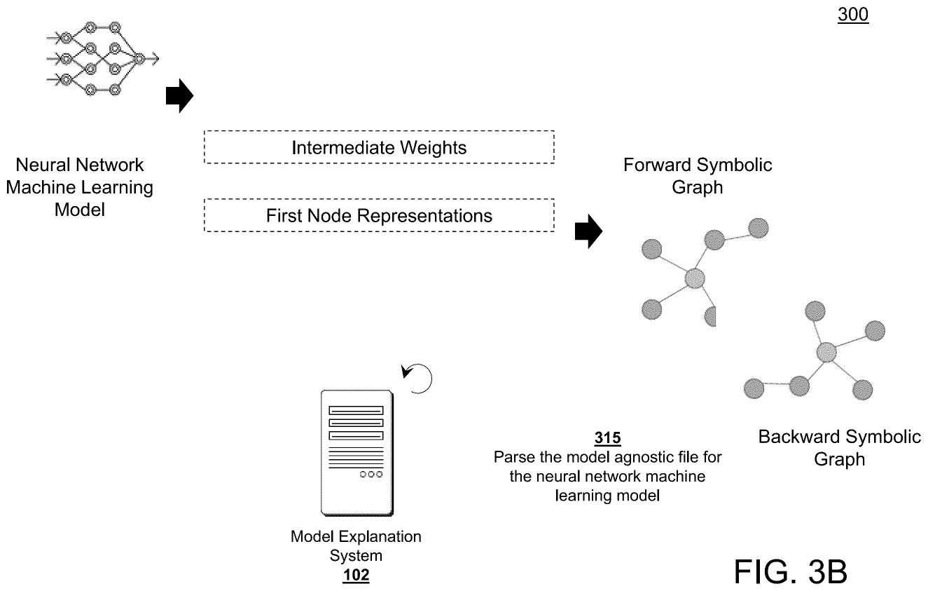

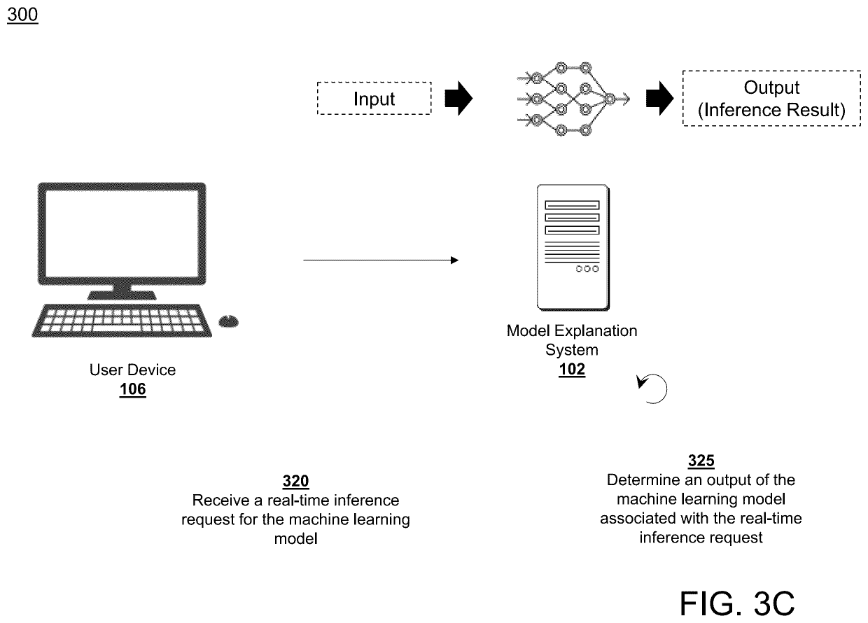

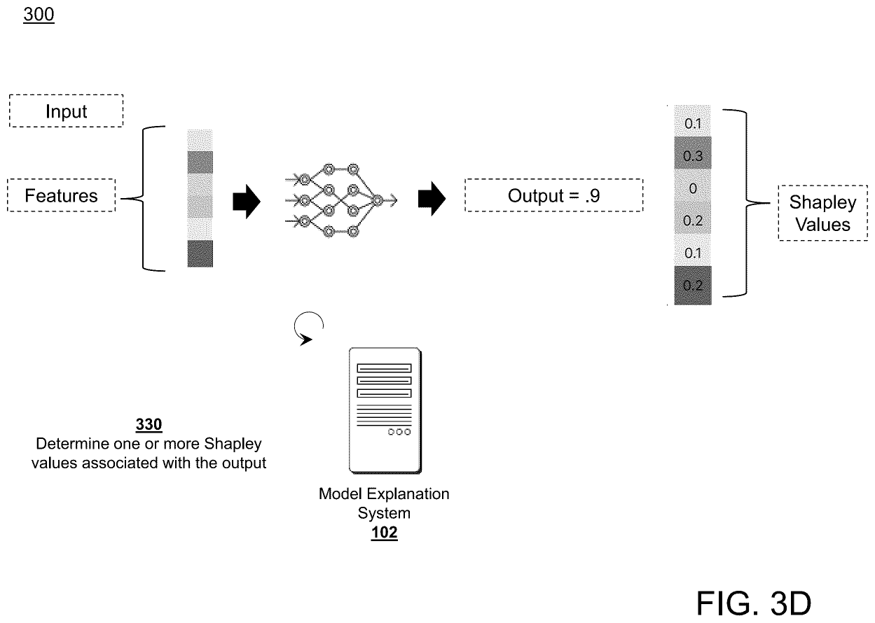

Referring now to FIGS. 3A-3D, shown are schematic diagrams of implementation 300 of a process (e.g., process 200) for implementing a model agnostic framework to provide Shapley values associated with a machine learning model. In some non-limiting embodiments or aspects, one or more of the steps of the process may be performed (e.g., completely, partially, etc.) by model explanation system 102 (e.g., one or more devices of model explanation system 102). In some non-limiting embodiments or aspects, one or more of the steps of the process may be performed (e.g., completely, partially, etc.) by another device or a group of devices separate from or including model explanation system 102 (e.g., one or more devices of model explanation system 102), ML model management database 104, and/or user device 106. As shown in implementation 300, Shapley values may be used to explain a difference in an output from a reference output in terms of difference of an input from a corresponding reference input, the difference may be used to measure an importance of a target input on an output (e.g., a prediction) of a machine learning model through backpropagation.

As shown by reference number 305 in FIG. 3A, model explanation system 102 may receive an executable file for a neural network machine learning model from ML model management database 104. In some non-limiting embodiments or aspects, for a neural network machine learning model, t may denote an output of a neuron in an intermediate layer of the neural network machine learning model and x₀, x₁, . . . . xₙ may denote inputs to compute t from the neuron.

A reference-from-difference Δt may be denoted as Δt=t−t₀, where to is the corresponding output of the neuron from a reference input x₀⁰, x₀¹, . . . xₙ⁰, (e.g., which may be chosen according to domain knowledge and/or heuristics), and model explanation system 102 may assign contribution scores CΔxᵢΔt to Δxᵢ s.t., according to the formula:

$${\sum }_{i = 1}^{n} {C}_{Δ {x}_{i} Δ t} = Δ t ,$$

where CΔxᵢΔt is the amount of difference-from-reference in t that is attributed to the difference-from-reference of xᵢ.

A multiplier (e.g., a derivative) may be defined by the formula:

$${m}_{Δ x Δ t} = \frac{{C}_{Δ x Δ t}}{Δ x}$$

where Δx is the difference-from-reference in input x and Δt is the difference-from-reference in output t. In some non-limiting embodiments or aspects, since the contribution of Δx to Δt is divided by the input difference, Δx, the multiplier may be used as a discrete version of a partial derivative. A chain rule for the multiplier may be defined as the following formula:

$${m}_{Δ {x}_{i} Δ t} = {\sum }_{j = 1}^{n} {m}_{Δ {x}_{i} Δ {y}_{j}} {m}_{Δ {y}_{j} Δ t}$$

where xi is the neuron input for layer Hₗ of the neural network machine learning model and y₀, y₁, . . . yₙ are neuron outputs for layer Hₗ and neuron inputs for a successive layer to Hₗ. An analogy to partial derivatives allows for computation of the contributions of the neural network machine learning model output with regard to the neural network machine learning model input via backpropagation. The Shapley values may be approximated by an average according to the following formula:

$$ϕ \approx Avg ( M * ( X - R ) )$$

where M is the final matrix computed by the multiplier with regard to the model input in the backpropagation and X is an input and R is a reference input. The present disclosure provides for implementing and accelerating computation of M in a model agnostic framework (e.g., an ONNX ecosystem) for a neural network machine learning model. In such a model agnostic framework, gradient computation may be adjusted for nonlinear operators (e.g., Sigmoid operators, MaxPooling operators, etc.), and original gradient computations may be used for linear operators (e.g., MatMul operators, Convolution (Conv) operators, etc.).

As further shown by reference number 310 in FIG. 3A, model explanation system 102 may convert a format of the executable file for the neural network machine learning model to model agnostic format to provide a model agnostic file. In some non-limiting embodiments or aspects, model explanation system 102 may convert a format of the executable file for the neural network machine learning model to an ONNX format to provide an ONNX file for the neural network machine learning model.

As shown by reference number 315 in FIG. 3B, model explanation system 102 may parse the model agnostic file for the neural network machine learning model. In some non-limiting embodiments or aspects, model explanation system 102 may parse an agnostic model format file (e.g., an ONNX file) for the neural network machine learning model to provide a forward symbolic graph and/or a backward symbolic graph associated with the neural network machine learning model. In some non-limiting embodiments or aspects, the forward symbolic graph and/or the backward symbolic graph associated with the neural network machine learning model may include a high-level representation of the computation flow of the neural network machine learning model. The forward symbolic graph and/or the backward symbolic graph may include a plurality of nodes (e.g., computation nodes) and a plurality of edges to define the structure (e.g., architecture) and/or operations of the neural network machine learning model. In some non-limiting embodiments or aspects, each node in the forward symbolic graph and/or the backward symbolic graph may represent an operator (e.g., addition, multiplication, convolution, etc.) and each edge may represent a data flow between the operators.

In some non-limiting embodiments or aspects, model explanation system 102 may generate a plurality of intermediate weights and/or a plurality of reference outputs of the neural network machine learning model based on reference input data provided to the machine learning model. For example, model explanation system 102 may provide the reference input data as an input to the neural network machine learning model, and the neural network machine learning model may provide a plurality of reference outputs of the neural network machine learning model based on the input. The plurality of intermediate weights may be generated during backpropagation as updates are made to model parameters of the neural network machine learning model based on forward propagation of the reference input data.

In some non-limiting embodiments or aspects, the intermediate weights and the plurality of reference outputs of the neural network machine learning model are based on reference input data provided to the neural network machine learning model. In the example above, model explanation system 102 may generate a forward symbolic graph associated with the neural network machine learning model and a backward symbolic graph associated with the neural network machine learning model. In some non-limiting embodiments or aspects, model explanation system 102 may generate the backward symbolic graph based on the forward symbolic graph.

In some non-limiting embodiments or aspects, model explanation system 102 may generate a loss function for the neural network machine learning model based on a difference between an output of the forward symbolic graph and the reference input data provided to the neural network machine learning model. In some non-limiting embodiments or aspects, model explanation system 102 may generate the backward symbolic graph associated with the neural network machine learning model based on the loss function for the neural network machine learning model.

In some non-limiting embodiments or aspects, model explanation system 102 may compute a gradient associated with the forward symbolic graph. For example, model explanation system 102 may compute a gradient between neighboring nodes of the plurality of nodes of the forward symbolic graph. In some non-limiting embodiments or aspects, model explanation system 102 may generate a plurality of nodes and/or a plurality of edges of a backward symbolic graph based on a gradient associated with the forward symbolic graph. For example, model explanation system 102 may generate a plurality of nodes and/or a plurality of edges of a backward symbolic graph based on the gradient between neighboring nodes of the plurality of nodes of the forward symbolic graph. In some non-limiting embodiments or aspects, model explanation system 102 may generate the backward symbolic graph associated with the neural network machine learning model to include one linear operator and/or one nonlinear operator.

In some non-limiting embodiments or aspects, model explanation system 102 may first establish the forward symbolic graph. In the forward symbolic graph, one node is linked to one or more other nodes because the output of the node may be either the input to another node or the output of the neural network machine learning model (e.g., a model associated with an agnostic model format file, such as an ONNX model). With that, model explanation system 102 may build a backward graph, which may not yet include a backward symbolic graph, but instead just a graph structure with nodes that carry information about the nodes of the forward symbolic graph. The information in each node of the backward graph may include the node itself, neighbors of the current node in the backward graph and a number of neighbors of that node, in-flowing and/or out-flowing gradients, and/or an optional argument that indicates whether gradients are passed (e.g., pass grads) to tell whether an input to a node is differential with regard to an input, which may be referred to as a model input, to the neural network machine learning model.

Some operators, such as Multiplication (Mul) and Addition (Add), allow two inputs to differentiate with a model input. Other operators, such as Matrix multiplication (MatMul) and General Matrix Multiply (Gemm), may allow up to two inputs to vary when only one input differentiates with a model input. In some non-limiting embodiments or aspects, model explanation system 102 may determine whether out-flowing gradients of a current node may be passed to neighboring nodes via pass grads when building the backward graph (e.g., using a Neural Network Parser).

In some non-limiting embodiments or aspects, a model agnostic framework may include a plurality of operators (e.g., hundreds of operators). In some non-limiting embodiments or aspects, model explanation system 102 may include defined gradients (e.g., for linear operators) or multipliers (e.g., for nonlinear operators) in a model agnostic framework. In some non-limiting embodiments or aspects, the plurality of operators may include Concatenation (Concat), Add, Mul, MatMul, Gemm, Sigmoid, ReLU, Softmax, Conv, MaxPool, AveragePool, GlobalAveragePool, Transpose, BatchNormalization, and others. When executing the forward symbolic graph, some resulting outputs for gradient computations may be stored in memory by model explanation system 102 for some operators. In this way, extra computation may be avoided when training a neural network machine learning model.

In some non-limiting embodiments or aspects, a linear rule for linear operations may be used to compute gradients and a rescale rule and/or a revealcancel rule may be used for nonlinear operations to compute multipliers. In some non-limiting embodiments or aspects, some operators using a forward symbolic graph for gradient computations and/or multiplier computations include Concat, Mul, Matmul, Sigmoid, Maxpooling, GlobalMaxPooling, Avgpooling, and/or GlobalAvgPooling.

Concat may be a linear operator, which has no local gradient. In some non-limiting embodiments or aspects, the incoming gradient may be split and/or passed to successive nodes in a backward path according to a portion of how the inputs to Concat are concatenated in a forward path. An effect of Mul can be either nonlinear or linear, depending on whether both inputs to the multiplication operation are differentiable with regard to a model input. If both inputs to the multiplication operation are differentiable with regard to a model input, model explanation system 102 may use a revealcancel rule to compute adjusted gradients. Otherwise, model explanation system 102 may multiply the incoming gradients with the input to the multiplication operation that is not differentiable with regard to the model input to compute outgoing gradients. In case of broadcasting, a smaller input may sum the incoming gradients over the axes that this input is broadcast across with the larger input of the multiplication operation.

Matmul is a linear operator and a local gradient of Matmul is a transpose of a weight with regard to the input. Multiplying the local gradient with an incoming gradient gives the outgoing gradient to the successors in a backward path. Conv is a linear operator that may be used to compute outgoing gradients for the Conv operation. Sigmoid is a nonlinear operation. The computation of adjusted gradients is defined according to the following formula:

$$σ ( x ) = \frac{1}{1 + {e}^{- x}}$$

$${grad}^{*} = \{ \begin{matrix}σ ( x ) ( 1 - σ ( x ) ) & if x - r < 1 e - 6 \\ \frac{σ ( x ) - σ ( r )}{x - r} & otherwise\end{matrix}$$

Where σ(x) is the output of Sigmoid, x is the input to some neurons for the data we want to explain, and r is the input to some neurons for reference data. If x−r<1e−6 returns true, the original gradients of Sigmoid may be used. Otherwise, the multiplier for Sigmoid may be used by a rescale rule. Multiplying grad* with incoming gradients may provide the outgoing gradients. In some non-limiting embodiments or aspects, most of activation functions use the same manner to obtain grad* except for Softmax which uses a revealcancel rule.

Maxpooling is a nonlinear operation, and the adjusted gradients for Maxpooling may be defined by the following formula:

$$C = max ( {y}_{x} , {y}_{r} )$$

$${M}_{x} = ( C - {y}_{r} ) \times {grad}_{in}$$

$${M}_{r} = ( {y}_{x} - C ) \times {grad}_{in}$$

$${grad}_{out}^{*} = \{ \begin{matrix}0 s & if x - r < 1 e - 7 \\ \frac{\frac{\partial {M}_{x}}{\partial x} + \frac{\partial {M}_{r}}{\partial r}}{x - r} & otherwise\end{matrix}$$

Where x and r are the inputs to maxpooling neurons for the input data and reference input data, respectively, and yₓ and yᵣ are outputs of these neurons. C is a cross maximum between yₓ and yᵣ element-wise. Incoming gradients gradᵢₙ are multiplied with C-yᵣ to attain cross positioned incoming gradients Mₓ. Likewise, Mᵣ is obtained. If x−r is less than 1e−7, the outgoing gradients

$${grad}_{out}^{*}$$

are zeros. Otherwise, the sum of positioned gradients of Maxpooling with regard to x and r are divided by x−r as outgoing gradients

$${grad}_{out}^{*} .$$

The incoming gradient may be passed back to neurons that achieve the maximum and all other neurons have zero gradients when calculating gradients for Maxpooling operations. Note that the gradients accumulate if the same neurons achieve the maximum in different pooling windows. GlobalMaxPooling may include a special case of Maxpooling whose pooling window size is the same as the input spatial. In addition, Avgpooling is a linear operation. To compute gradients with regard to an input of an Avgpooling operation, the incoming gradients may be distributed equally to the locations within the pooling window and the gradients may accumulate if two pooling windows overlap. Further, GlobalAvgPooling is a special case of Avgpooling whose pooling window size is the same as the input spatial.

In some non-limiting embodiments or aspects, an automatic differentiation algorithm may be useful for implementing machine learning techniques, such as back-propagation (e.g., for training neural network machine learning models). In some non-limiting embodiments or aspects, model explanation system 102 may implement an automatic differentiation algorithm that conducts a Depth First Search (DFS) to identify all of the operators in a backward path from an output to an input of the model and sums partial gradients that each operator contributes. In some non-limiting embodiments or aspects, there may be a plurality of types of gradient flows analyzed when using DFS. For example, four types of gradient flows may include one2one, many2one, one2many, and many2many.

In a one2one type of gradient flow, both incoming and outgoing gradients have one branch, and the incoming gradients are multiplied with the local gradients (e.g., if any) to obtain outgoing gradients. A one2one type of gradient flow may include activation functions, which are typical operators of this type. If the operator has no local gradients, the incoming gradients are passed to the successors in the backward path. In a many2one type of gradient flow, there are multiple flows of incoming gradients but only one flow of outgoing gradients. All incoming gradients are summed at first and then the summation is multiplied with the local gradients (e.g., if any) to obtain the outgoing gradients. In a one2many type of gradient flow, there is one flow of incoming gradients and multiple flows of outgoing gradients. After multiplying the incoming gradients with local gradients (e.g., if any), the outgoing gradients are split or assigned to the successors. A many2many type of gradient flow is the combination of many2one and one2many.

In some non-limiting embodiments, model explanation system 102 may use a DFS algorithm to reverse a forward symbolic graph to compute one or more Shapley values. The procedure to compute Shapley values using DFS is provided as follows:

| | |
|---|---|
| 1: | Let S be the stack. |
| 2: | S.push(N) |
| 3: | Mark N as visited. |
| 4: | Define the difference-from-reference yₓ − yᵣ as the loss |
| | gradᵢₙ. {y is the output of model.} |
| 5: | while S is not empty do |
| 6: | C ← S.pop( ) |
| 7: | O, gradᵢₙ ← F_{grad}(C, G, gradᵢₙ) {F_{grad} is the |
| | function to compute gradients/multipliers for opera- |
| | tors.} |
| 8: | Append O to L. |
| 9: | for neighbor W of C in G do |
| 10: | if W is not visited and it gets all gradient flows |
| | then |
| 11: | S.push(W) |
| 12: | Mark W as visited. |
| 13: | end if |
| 14: | end for |
| 15: | end while |
| 16: | return L |

In the procedure above, the input includes the backward graph, G, the first computation node, N, and the output includes the Gradient node list, L. In some non-limiting embodiments or aspects, DFS takes the backward graph G and the first computation node N as inputs and returns a list of computation nodes. In some non-limiting embodiments or aspects, the backward graph G is obtained based on parsing the agnostic model format file for the neural network machine learning model and N is the first computation node in the backward path. Each node in G contains information to perform DFS and the name of the visiting computation node is used to get that information. From lines 1-3, an empty stack is created and N is pushed onto the stack, marking N as visited. Line 4 defines the loss yₓ-yᵣ to compute gradients with regard to the model input. The rest of the DFS algorithm details how to traverse all computations nodes in the backward path. Function F_{grad} returns a list of computation nodes 0 to compute gradients for the visiting node C and the incoming gradients gradᵢₙ for the next node in line 7. If the neighboring node W of C is not visited and it receives all incoming gradient flows, W is pushed onto the stack and marked as visited. In some non-limiting embodiments or aspects, the use of the automatic differentiation algorithm (e.g., including DFS) optimizes approaches to generate Shapley values (e.g., by caching commonly-used intermediate outputs during the forward path for backpropagation) and simplifies a computation graph (e.g., a backward symbolic graph based on a forward symbolic graph) to generate Shapley values.

As shown by reference number 320 in FIG. 3C, model explanation system 102 may receive a real-time inference request for the neural network machine learning model from user device 106. As further shown by reference number 325 in FIG. 3C, model explanation system 102 may determine an output of the neural network machine learning model associated with the real-time inference request.

In some non-limiting embodiments or aspects, model explanation system 102 may determine the output of the neural network machine learning model associated with an input included in the real-time inference request using the neural network machine learning model. For example, model explanation system 102 may generate a score (e.g., a model score, a prediction score, etc.) based on an input provided to the neural network machine learning model. In such an example, model explanation system 102 may generate the score based on an input included with an inference request and that is provided to the neural network machine learning model to generate the score. In some non-limiting embodiments or aspects, a score for an input (e.g., a data instance) may be equal to an average model score (e.g., an average model score for all inputs of a plurality of inputs) added to a sum of the Shapley values for each feature of a plurality of features included in the input.

As shown by reference number 330 in FIG. 3D, model explanation system 102 may determine one or more Shapley values associated with the output. In some non-limiting embodiments or aspects, model explanation system 102 may determine the one or more Shapley values associated with the output of the neural network machine learning model based on the backward symbolic graph, the plurality of intermediate weights, and/or the plurality of reference outputs of the neural network machine learning model (e.g., the plurality of reference outputs of the neural network machine learning model stored in a cache memory location). In some non-limiting embodiments or aspects, when determining the one or more Shapley values associated with the output of the neural network machine learning model, model explanation system 102 may apply an automatic differentiation algorithm to the backward symbolic graph.

In some non-limiting embodiments or aspects, model explanation system 102 may generate (e.g., determine) a score associated with an inference task based on an output of the neural network machine learning model that was generated based on input data (e.g., input data included in an inference request) provided to the neural network machine learning model as an input. In one example, model explanation system 102 may generate a fraud detection score based on the output of the neural network machine learning model, and the one or more Shapley values associated with the output of the neural network machine learning model may include an indication of one or more features of input data that affected the fraud detection score.

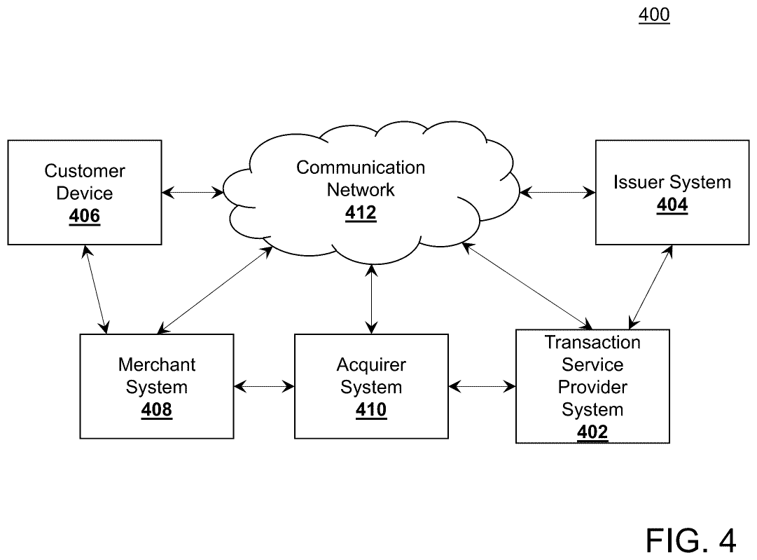

Referring now to FIG. 4, shown is a diagram of a non-limiting embodiment or aspect of exemplary environment 400 in which methods, systems, and/or products, as described herein, may be implemented. As shown in FIG. 4, environment 400 may include transaction service provider system 402, issuer system 404, customer device 406, merchant system 408, acquirer system 410, and communication network 412. In some non-limiting embodiments or aspects, each of model explanation system 102, ML model management database 104, and/or user device 106 of FIG. 1 may be implemented by (e.g., part of) transaction service provider system 402. In some non-limiting embodiments or aspects, at least one of model explanation system 102, ML model management database 104, and/or user device 106 of FIG. 1 may be implemented by (e.g., part of) another system, another device, another group of systems, or another group of devices, separate from or including transaction service provider system 402, such as issuer system 404, customer device 406, merchant system 408, acquirer system 410, and/or the like.

Transaction service provider system 402 may include one or more devices capable of receiving information from and/or communicating information to issuer system 404, customer device 406, merchant system 408, and/or acquirer system 410 via communication network 412. For example, transaction service provider system 402 may include a computing device, such as a server (e.g., a transaction processing server), a group of servers, and/or other like devices. In some non-limiting embodiments or aspects, transaction service provider system 402 may be associated with a transaction service provider, as described herein. In some non-limiting embodiments or aspects, transaction service provider system 402 may be in communication with a data storage device, which may be local or remote to transaction service provider system 402. In some non-limiting embodiments or aspects, transaction service provider system 402 may be capable of receiving information from, storing information in, communicating information to, or searching information stored in the data storage device.

Issuer system 404 may include one or more devices capable of receiving information and/or communicating information to transaction service provider system 402, customer device 406, merchant system 408, and/or acquirer system 410 via communication network 412. For example, issuer system 404 may include a computing device, such as a server, a group of servers, and/or other like devices. In some non-limiting embodiments or aspects, issuer system 404 may be associated with an issuer institution, as described herein. For example, issuer system 404 may be associated with an issuer institution that issued a credit account, debit account, credit card, debit card, and/or the like to a user associated with customer device 406.

Customer device 406 may include one or more devices capable of receiving information from and/or communicating information to transaction service provider system 402, issuer system 404, merchant system 408, and/or acquirer system 410 via communication network 412. Additionally or alternatively, each customer device 406 may include a device capable of receiving information from and/or communicating information to other customer devices 406 via communication network 412, another network (e.g., an ad hoc network, a local network, a private network, a virtual private network, and/or the like), and/or any other suitable communication technique. For example, customer device 406 may include a client device and/or the like. In some non-limiting embodiments or aspects, customer device 406 may or may not be capable of receiving information (e.g., from merchant system 408 or from another customer device 406) via a short-range wireless communication connection (e.g., an NFC communication connection, an RFID communication connection, a Bluetooth® communication connection, a Zigbee® communication connection, and/or the like), and/or communicating information (e.g., to merchant system 408) via a short-range wireless communication connection.

Merchant system 408 may include one or more devices capable of receiving information from and/or communicating information to transaction service provider system 402, issuer system 404, customer device 406, and/or acquirer system 410 via communication network 412. Merchant system 408 may also include a device capable of receiving information from customer device 406 via communication network 412, a communication connection (e.g., an NFC communication connection, an RFID communication connection, a Bluetooth® communication connection, a Zigbee® communication connection, and/or the like) with customer device 406, and/or the like, and/or communicating information to customer device 406 via communication network 412, the communication connection, and/or the like. In some non-limiting embodiments or aspects, merchant system 408 may include a computing device, such as a server, a group of servers, a client device, a group of client devices, and/or other like devices. In some non-limiting embodiments or aspects, merchant system 408 may be associated with a merchant, as described herein. In some non-limiting embodiments or aspects, merchant system 408 may include one or more client devices. For example, merchant system 408 may include a client device that allows a merchant to communicate information to transaction service provider system 402. In some non-limiting embodiments or aspects, merchant system 408 may include one or more devices, such as computers, computer systems, and/or peripheral devices capable of being used by a merchant to conduct a transaction with a user. For example, merchant system 408 may include a POS device and/or a POS system.

Acquirer system 410 may include one or more devices capable of receiving information from and/or communicating information to transaction service provider system 402, issuer system 404, customer device 406, and/or merchant system 408 via communication network 412. For example, acquirer system 410 may include a computing device, a server, a group of servers, and/or the like. In some non-limiting embodiments or aspects, acquirer system 410 may be associated with an acquirer, as described herein.

Communication network 412 may include one or more wired and/or wireless networks. For example, communication network 412 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 4 are provided as an example. There may be additional systems, devices, and/or networks; fewer systems, devices, and/or networks; different systems, devices, and/or networks; and/or differently arranged systems, devices, and/or networks than those shown in FIG. 4. Furthermore, two or more systems or devices shown in FIG. 4 may be implemented within a single system or device, or a single system or device shown in FIG. 4 may be implemented as multiple, distributed systems or devices. Additionally or alternatively, a set of systems (e.g., one or more systems) or a set of devices (e.g., one or more devices) of environment 400 may perform one or more functions described as being performed by another set of systems or another set of devices of environment 400.

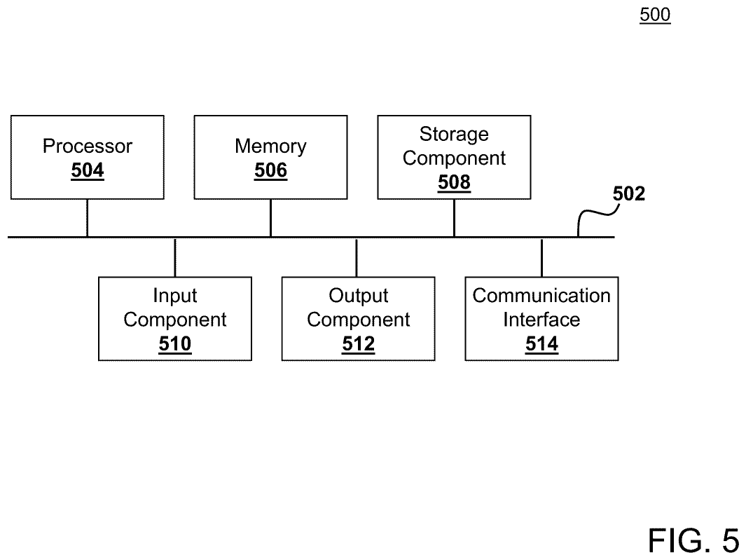

Referring now to FIG. 5, shown is a diagram of example components of device 500, according to non-limiting embodiments or aspects. Device 500 may correspond to at least one of model explanation system 102, ML model management database 104, and/or user device 106 in FIG. 1 and/or at least one of transaction service provider system 402, issuer system 404, customer device 406, merchant system 408, and/or acquirer system 410 in FIG. 4, as an example. In some non-limiting embodiments or aspects, such systems or devices in FIG. 1 or FIG. 4 may include at least one device 500 and/or at least one component of device 500. The number and arrangement of components shown in FIG. 5 are provided as an example. In some non-limiting embodiments or aspects, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments or aspects, processor 504 may be implemented in hardware, firmware, or a combination of hardware and software. For example, processor 504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 506 may include random access memory (RAM), read only memory (ROM), and/or another type of dynamic or static storage device (e.g., flash memory, magnetic memory, optical memory, etc.) that stores information and/or instructions for use by processor 504.

With continued reference to FIG. 5, storage component 508 may store information and/or software related to the operation and use of device 500. For example, storage component 508 may include a hard disk (e.g., a magnetic disk, an optical disk, a magneto-optic disk, a solid-state disk, etc.) and/or another type of computer-readable medium. Input component 510 may include a component that permits device 500 to receive information, such as via user input (e.g., a touch screen display, a keyboard, a keypad, a mouse, a button, a switch, a microphone, etc.). Additionally or alternatively, input component 510 may include a sensor for sensing information (e.g., a global positioning system (GPS) component, an accelerometer, a gyroscope, an actuator, etc.). Output component 512 may include a component that provides output information from device 500 (e.g., a display, a speaker, one or more light-emitting diodes (LEDs), etc.). Communication interface 514 may include a transceiver-like component (e.g., a transceiver, a separate receiver and transmitter, etc.) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium may include any non-transitory memory device. A memory device includes memory space located inside of a single physical storage device or memory space spread across multiple physical storage devices. Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, an executable file for a neural network machine learning model;
converting, with at least one processor, a format of the executable file for the neural network machine learning model to an agnostic model format to provide an agnostic model format file for the neural network machine learning model;
parsing, with at least one processor, the agnostic model format file for the neural network machine learning model, wherein parsing the agnostic model format file for the neural network machine learning model comprises:
storing, with at least one processor, a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model;
generating, with at least one processor, a forward symbolic graph associated with the neural network machine learning model; and
generating, with at least one processor, a backward symbolic graph associated with the neural network machine learning model based on the forward symbolic graph;
receiving, with at least one processor, a real-time inference request for the neural network machine learning model;
determining, with at least one processor, an output of the neural network machine learning model associated with the real-time inference request using the neural network machine learning model; and
determining, with at least one processor, one or more Shapley values associated with the output of the neural network machine learning model based on the backward symbolic graph and the plurality of intermediate weights and the plurality of reference outputs of the neural network machine learning model stored in the cache memory location.

2. The computer-implemented method of claim 1, further comprising:
generating a loss function for the neural network machine learning model based on a difference between an output of the forward symbolic graph and the reference input data provided to the neural network machine learning model.

3. The computer-implemented method of claim 2, wherein generating the backward symbolic graph associated with the neural network machine learning model comprises:
generating the backward symbolic graph associated with the neural network machine learning model based on the loss function for the neural network machine learning model.

4. The computer-implemented method of claim 1, wherein the forward symbolic graph comprises a plurality of nodes and a plurality of edges, and wherein generating the backward symbolic graph associated with the neural network machine learning model comprises:
computing a gradient between neighboring nodes of the plurality of nodes of the forward symbolic graph; and
generating a plurality of nodes and a plurality of edges of the backward symbolic graph based on the gradient between neighboring nodes of the plurality of nodes of the forward symbolic graph.

5. The computer-implemented method of claim 1, wherein generating the backward symbolic graph associated with the neural network machine learning model comprises:
generating the backward symbolic graph associated with the neural network machine learning model to include one linear operator and one nonlinear operator.

6. The computer-implemented method of claim 1, wherein determining the one or more Shapley values associated with the output of the neural network machine learning model comprises:
applying an automatic differentiation algorithm to the backward symbolic graph.

7. The computer-implemented method of claim 1, further comprising:
determining a fraud detection score based on the output of the neural network machine learning model,
wherein the one or more Shapley values associated with the output of the neural network machine learning model comprise an indication of one or more features of input data included in the real-time inference request that affected the fraud detection score.

8. A system, comprising:
at least one processor configured to:
receive an executable file for a neural network machine learning model;
convert a format of the executable file for the neural network machine learning model to an agnostic model format to provide an agnostic model format file for the neural network machine learning model;
parse the agnostic model format file for the neural network machine learning model, wherein, when parsing the agnostic model format file for the neural network machine learning model, the at least one processor is configured to:
store a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model;
generate a forward symbolic graph associated with the neural network machine learning model; and
generate a backward symbolic graph associated with the neural network machine learning model based on the forward symbolic graph;
receive a real-time inference request for the neural network machine learning model;
determine an output of the neural network machine learning model associated with the real-time inference request using the neural network machine learning model; and
determine one or more Shapley values associated with the output of the neural network machine learning model based on the backward symbolic graph and the plurality of intermediate weights and the plurality of reference outputs of the neural network machine learning model stored in the cache memory location.

9. The system of claim 8, wherein the at least one processor is further configured to:
generate a loss function for the neural network machine learning model based on a difference between an output of the forward symbolic graph and the reference input data provided to the neural network machine learning model.

10. The system of claim 9, wherein, when generating the backward symbolic graph associated with the neural network machine learning model, the at least one processor is configured to:
generate the backward symbolic graph associated with the neural network machine learning model based on the loss function for the neural network machine learning model.

11. The system of claim 8, wherein the forward symbolic graph comprises a plurality of nodes and a plurality of edges, and wherein, when generating the backward symbolic graph associated with the neural network machine learning model, the at least one processor is configured to:
compute a gradient between neighboring nodes of the plurality of nodes of the forward symbolic graph; and
generate a plurality of nodes and a plurality of edges of the backward symbolic graph based on the gradient between neighboring nodes of the plurality of nodes of the forward symbolic graph.

12. The system of claim 8, wherein, when generating the backward symbolic graph associated with the neural network machine learning model, the at least one processor is configured to:
generate the backward symbolic graph associated with the neural network machine learning model to include one linear operator and one nonlinear operator.

13. The system of claim 8, wherein, when determining the one or more Shapley values associated with the output of the neural network machine learning model, the at least one processor is configured to:
apply an automatic differentiation algorithm to the backward symbolic graph.

14. The system of claim 8, wherein the at least one processor is further configured to:
determine a fraud detection score based on the output of the neural network machine learning model; and
wherein the one or more Shapley values associated with the output of the neural network machine learning model comprise an indication of one or more features of input data included in the real-time inference request that affected the fraud detection score.

15. A computer program product comprising at least one non-transitory computer-readable medium including program instructions that, when executed by at least one processor, cause the at least one processor to:
receive an executable file for a neural network machine learning model;
convert a format of the executable file for the neural network machine learning model to an agnostic model format to provide an agnostic model format file for the neural network machine learning model;
parse the agnostic model format file for the neural network machine learning model, wherein, the program instructions that cause the at least one processor to parse the agnostic model format file for the neural network machine learning model, cause the at least one processor to:
store a plurality of intermediate weights and a plurality of reference outputs of the neural network machine learning model in a cache memory location, wherein the plurality of intermediate weights and the plurality of reference outputs of the neural network machine learning model are based on reference input data provided to the neural network machine learning model;
generate a forward symbolic graph associated with the neural network machine learning model; and
generate a backward symbolic graph associated with the neural network machine learning model based on the forward symbolic graph;
receive a real-time inference request for the neural network machine learning model;
determine an output of the neural network machine learning model associated with the real-time inference request using the neural network machine learning model; and
determine one or more Shapley values associated with the output of the neural network machine learning model based on the backward symbolic graph and the plurality of intermediate weights and the plurality of reference outputs of the neural network machine learning model stored in the cache memory location.

16. The computer program product of claim 15, wherein the program instructions further cause the at least one processor to:
generate a loss function for the neural network machine learning model based on a difference between an output of the forward symbolic graph and the reference input data provided to the neural network machine learning model.

17. The computer program product of claim 16, wherein, the program instructions that cause the at least one processor to generate the backward symbolic graph associated with the neural network machine learning model, cause the at least one processor to:
generate the backward symbolic graph associated with the neural network machine learning model based on the loss function for the neural network machine learning model.

18. The computer program product of claim 15, wherein the forward symbolic graph comprises a plurality of nodes and a plurality of edges, and wherein, the program instructions that cause the at least one processor to generate the backward symbolic graph associated with the neural network machine learning model, cause the at least one processor to:
compute a gradient between neighboring nodes of the plurality of nodes of the forward symbolic graph; and
generate a plurality of nodes and a plurality of edges of the backward symbolic graph based on the gradient between neighboring nodes of the plurality of nodes of the forward symbolic graph.

19. The computer program product of claim 15, wherein, the program instructions that cause the at least one processor to generate the backward symbolic graph associated with the neural network machine learning model, cause the at least one processor to:
generate the backward symbolic graph associated with the neural network machine learning model to include one linear operator and one nonlinear operator.

20. The computer program product of claim 15, wherein, the program instructions that cause the at least one processor to determine the one or more Shapley values associated with the output of the neural network machine learning model, cause the at least one processor to:
apply an automatic differentiation algorithm to the backward symbolic graph.

21. The computer program product of claim 15, wherein the program instructions further cause the at least one processor to:
determine a fraud detection score based on the output of the neural network machine learning model; and
wherein the one or more Shapley values associated with the output of the neural network machine learning model comprise an indication of one or more features of input data included in the real-time inference request that affected the fraud detection score.
